(19) United States
(12) Patent Application Publication
(10) Pub. No.: US 2024/0112177 A1
(43) Pub. Date: Apr. 4, 2024

(54) SYSTEMS AND METHODS FOR IDENTITY VERIFICATION TO AUTHORIZE TRANSACTIONS IN DECENTRALIZED NETWORKS

(71) Applicant: DeFi Labs GmbH, Berlin (DE)

(72) Inventors: Markus Maier, Berlin (DE); Philipp Banhardt, Berlin (DE)

(21) Appl. No.: 18/480,054

(22) Filed: Oct. 3, 2023

Related U.S. Application Data
(60) Provisional application No. 63/412,929, filed on Oct. 4, 2022.

(51) Int. Cl. G06Q 20/36; G06Q 20/02; G06Q 20/38; G06Q 20/40

(52) U.S. Cl. CPC G06Q 20/3674; G06Q 20/02; G06Q 20/38215; G06Q 20/4012

(57) ABSTRACT

The disclosed technology relates to identity verification in blockchain transactions. An exemplary identity management system may receive an authorization request that can include a wallet address, a blockchain network identifier, a dApp smart contract address, a function signature, transaction data, and a redirect address. The wallet address is enrolled by providing obtained user data to a KYC provider system, receiving validated user data, providing the validated user data to a sanction provider system, and receiving a sanction list result. A access token is issued that includes an issuer identifier, the function signature, the dApp smart contract address, and an indication of wallet address successfully enrollment. A message is then returned that includes the access token and the transaction data. The dApp smart contract is configured to execute the function after verifying the access token via an identity verification smart contract that is inherited by the dApp smart contract.

### CROSS-REFERENCE TO RELATED APPLICATIONS

This application claims priority to U.S. Provisional Patent Application No. 63/412,929, filed Oct. 4, 2022, which is incorporated herein by reference in its entirety.

### FIELD

The disclosed technology relates to systems and methods for validating identity and authorizing transactions in decentralized networks with increased security, in compliance with regulatory requirements, and without storing sensitive information on blockchain networks, for example.

### BACKGROUND

Decentralized ledgers, such as blockchains, are important tools in the digital economy that are used to manage digital assets, from fine art to currency, the latter often referred to as cryptocurrency. As adoption of decentralized finance (DeFi) applications continues to increase, DeFi operators face unique challenges, including the need to grow regulatory trust in their platforms and the desire to engage institutional liquidity. Building trust and institutional participation requires compliance rails that are integral with blockchain networks (i.e., “on-chain”). In other words, to effectively exploit the growth opportunity and advantages associated with the integration of DeFi across the entire financial stack, DeFi markets and operators need to continuously satisfy worldwide compliance regimes while balancing user privacy.

Currently, verification of user identity and authorization of transactions initiated against smart contracts deployed in blockchain networks is non-existent, failing to adequately maintain user sensitive information in part because of the transparency inherent in blockchain networks. These and other issues in current DeFi deployments and platforms are a significant impediment to the growth and trust in the digital economy environment.

### SUMMARY

Examples of the present disclosure provide solutions to the issues associated with identity verification for transactions in decentralized networks. The present disclosure describes and illustrates an identity management system that provides compliance and identity rails for blockchain transactions by combining the issuance of compliance credentials in the form of non-transferable access tokens (e.g., Ethereum access tokens (EATs)), and mapping of smart contract access controls on a blockchain network, with resilient authentication (i.e., proof of identity). Credential holders are subject to know your customer/know your business customer or client (KYC/KYB) verification (commonly referred to herein as KYC), continuous multi-factor authentication, geofencing, blockchain analytics, and continuous sanction (e.g., Office of Foreign Assets Control (OFAC)) screening. This technology also facilitates identity verification and transaction authorization in decentralized networks without storing sensitive data on-chain. Thus, the disclosed technology advantageously provides more robust security in compliance with regulatory requirements for authorized transactions in decentralized networks.

In one example, the identity management system may receive a request to authorize a transaction from a decentralized application (dApp) frontend executing on a client device. The request can include a wallet address, an identifier of a blockchain network, a smart contract address of a dApp smart contract, a function signature of a function associated with the transaction and executable via the dApp smart contract, transaction data, and a redirect address. The identity management system may then enroll the wallet address by providing user data obtained from the client device to a know your customer (KYC) provider system, receiving validated user data from the KYC provider system, providing the validated user data to a sanction provider system, and receiving a sanction list result from the sanction provider system. The identity management system may issue an access token (e.g., an Ethereum Access Token (EAT)) 1 comprising a signature bound to the parameters of the transaction the access token. The dApp smart contract is configured to execute the function after verifying the access token using predefined public keys associated with the identity management system.

In another example, a method for identity verification to authorize transactions in decentralized networks is disclosed that is implemented by one or more identity management systems and may include receiving a request to authorize a transaction from a dApp frontend executing on a client device. The request may include a wallet address, an identifier of a blockchain network, a smart contract address of a dApp smart contract, a function signature of a function associated with the transaction and executable via the dApp smart contract, transaction data, and a redirect address. The method may also include authenticating the wallet address via a multi-factor authentication process and validated user data and a sanction list result retrieved from one or more sensitive data storage devices. The method may further include issuing an access token (e.g., an EAT) to authorize transactions. Even further, the method may include returning a redirect message to the client device based on the redirect address to facilitate submission of the transaction to the dApp smart contract. The redirect message may include the access token and the transaction data and the dApp smart contract is configured to execute the function after verifying the access token.

In yet another example, a non-transitory computer readable medium is disclosed that has stored thereon instructions comprising executable code that, when executed by one or more processors, causes the processors to deploy on a blockchain network a token verification smart contract and an identity verification smart contract. The identity verification smart contract may include an extension with a connector to the token verification smart contract and is inherited by a dApp smart contract associated with a dApp. A user of a client device is then authenticated based on a wallet associated with the user. The wallet has a corresponding wallet address on the blockchain network. Validated user data indicating successful completion of a KYC process by the user and a positive sanction list result for the user are received from one or more external systems. An access token is then issued that authorizes a minting transaction to mint, for the wallet address on the blockchain network, a verifier token that comprises the access token, wherein the token verification smart contract is configured to provide credential verification via the extension for a transaction associated with the dApp based on the verifier token.

Other embodiments, features, and aspects of the disclosed technology are described in detail herein and are considered a part of the claimed disclosed technologies. Other embodiments, features, and aspects can be understood with reference to the following detailed description, accompanying drawings, and claims.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner. In the drawings:

FIG. 1 is a block diagram of an example network environment that includes an identity management system in accordance with one or more examples of the disclosed technology;

FIG. 2 is a component diagram of an identity management system, in accordance with one or more examples of the disclosed technology;

FIG. 3 is a timing diagram of an example method for identity verification to authorize transactions in decentralized networks, in accordance with one or more examples of the disclosed technology;

FIG. 4 is a flow diagram of an example method for communicating and storing sensitive data to facilitate improved identity management and verification, in accordance with one or more examples of the disclosed technology;

FIG. 5 is a timing diagram of an example method for facilitating a self-service portal for identity management, in accordance with one or more examples of the disclosed technology;

FIG. 6 is a timing diagram of an example method for enrolling users in an identity management system, in accordance with one or more examples of the disclosed technology;

FIG. 7 is a timing diagram of an example method for authorizing a user to perform a compliant transaction on a blockchain network via identity verification, in accordance with one or more examples of the disclosed technology;

FIG. 8 is a timing diagram of an example method for periodic user sanction list verification, in accordance with one or more examples of the disclosed technology; and

FIG. 9 is a flow diagram of an example method for providing an on-chain representation of an off-chain verified identity, in accordance with one or more examples of the disclosed technology.

### DETAILED DESCRIPTION

Examples of the disclosed technology provide highly customizable compliance and identity rails for blockchain networks. The identity management system 102 of this technology combines the issuance of compliance credentials in the form of non-transferable tokens (e.g., Ethereum access tokens (EATs)), and mapping of smart contract access controls on a blockchain network (e.g., an Ethereum network), with resilient authentication (i.e., proof of identity) to advantageously enable DeFi markets and operators to create permissioned environments accessible only to credential holders. The credential holders are subject to know your customer or client (KYC) verification, continuous multi-factor authentication, and continuous sanction (e.g., Office of Foreign Assets Control (OFAC)) screening.

More specifically, the identity management system 102 uses a regulated, third-party KYC provider system 108 to verify the users behind an Ethereum wallet application 118, for example. The KYC provider system 108 supports biometric verification, document verification, identity (ID) document face matching, and/or liveness detection. Further, users can authenticate themselves vis-a-vis permissioned protocols using this compliance credential issued by the identity management system 102 plus a second factor (e.g., short message system (SMS) one-time passcode (OTP), Google Authenticator™, Authy™, WebAuthn API, or Passkeys. The second factor does not only tie a blockchain network 106 wallet to a specific user of the client device 104 (minimizing the threat of whitewashing wallets), but also safeguards users against identity theft and ensures identity continuity.

Additionally, the identity management system 102 advantageously facilitates identity verification and transaction authorization in decentralized networks without storing sensitive data (e.g., personally identifiable information (PII)) obtained during enrollment on-chain and while requiring user authorization for sensitive data access. Thus, the decentralized application (dApp) frontend 120 needs user authorization to access any sensitive data. As will be described and illustrated in more detail below, by leveraging an access token issued by the identity management system 102 that can be verified by an integrating dApp frontend 120 on-chain using an identity verification smart contract 128 to connect a verified identity to a wallet associated with the wallet application 118, the disclosed technology provides more robust security in compliance with regulatory requirements for authorized transactions in decentralized networks.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Reference will now be made in detail to exemplary embodiments of the disclosed technology, examples of which are illustrated in the accompanying drawings and disclosed herein. Wherever convenient, the same reference numbers will be used throughout the drawings to refer to the same or like parts.

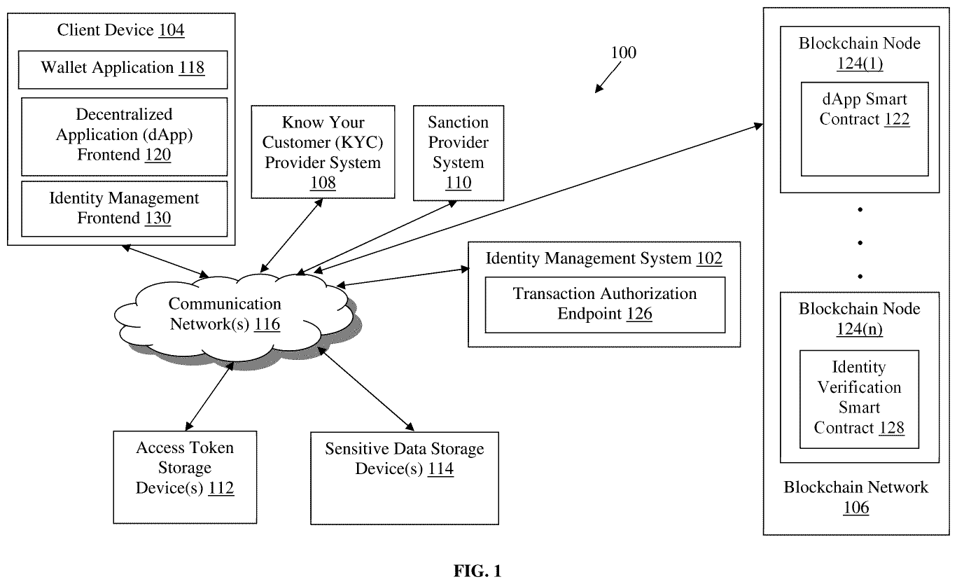

FIG. 1 is a block diagram of an example network environment 100 that includes an identity management system 102, a client device 104, a blockchain network 106, a KYC provider system 108, a sanction provider system 110, access token storage device(s) 112, and sensitive data storage device(s) 114, in accordance with one or more examples of the disclosed technology. The identity management system 102, client device 104, blockchain network 106, KYC provider system 108, sanction provider system 110, access token storage device(s) 112, and sensitive data storage device(s) 114 are coupled together via communication network(s) 116, such as one or more wide area networks (WANs), for example.

The client device 104 can be a mobile computing device (e.g., a smart phone, tablet computer, smart wearable (e.g., a smart watch), portable laptop computer, voice command device, wearable augmented reality device, or other mobile computing device) or a stationary device (e.g., desktop computer), for example. This, the client device 104 includes a processor coupled to a memory and configured to execute instructions stored in the memory to carry out various tasks as described and illustrated by way of the examples herein.

The client device 104 hosts a wallet application 118 (e.g., MetaMask™) in this example, although other types of payment or other blockchain clients configured to manage and maintain digital assets and communicate with the blockchain network 106 can also be used. The wallet application 118 can provide an interface to the blockchain network 106, facilitate the enrollment process described and illustrated in detail below, and/or optionally store non-fungible tokens (NFTs) issued by the identity management system 102.

The client device 104 in this example also hosts a dApp frontend 120 via which a user of the client device 104 can initiate a transaction requiring identity verification. The transaction can be initiated against the dApp smart contract 122 hosted by one of the blockchain nodes 124(1) of the blockchain network 106, for example. The dApp frontend 120 in this example is configured to redirect the transaction to the transaction authorization endpoint 126 hosted by the identity management system 102 in the form of an authorization request. As explained in more detail below, the identity management system 102 will respond with an access token if the transaction is authorized, and the user identity verified, which is received by the dApp frontend 120.

With the access token, the dApp frontend 120 is configured to finalize the transaction and then the same with the access token to the dApp smart contract 122. The dApp smart contract 122 is configured to verify the access token via the identity verification smart contract 128 hosted by another of the blockchain nodes 124(n) of the blockchain network 106, to thereby enforce identity and regulatory compliance. The dApp smart contract 122 thereafter executes the function(s) required to carry out the transaction, which will also be explained in more detail below.

Thus, each of the blockchain nodes 124(1)-124(n) of the blockchain network 106 includes a processor coupled to a memory and configured to execute instructions stored in the memory to carry out various tasks as described and illustrated by way of the examples herein. One or more of the blockchain nodes 124(1)-124(n) can be a personal computing device similar to the client device 104 or another device, such as a server. The blockchain nodes 124(1)-106(n) can process transactions made on the blockchain network 106 (e.g., trades or payments in cryptocurrency) using the dApp smart contract 122 and identity verification smart contract 128.

Each of the dApp smart contract 122 and the identity verification smart contract 128 is a set of executable instructions configured to automatically carry out an action, function, or task in furtherance of a transaction when condition(s) specified in the smart contract are satisfied. For example, the dApp smart contract 122 is configured to communicate with the identity verification smart contract 128 to obtain an authorization of a transaction, which it can then carry out (e.g., transfer digital assets to a third party). The identity verification smart contract 128 is configured to verify an access token provided by the dApp smart contract 122 and return a result of the verification. The operation of the dApp smart contract 122 and identity verification smart contract 128 will be described in more detail below.

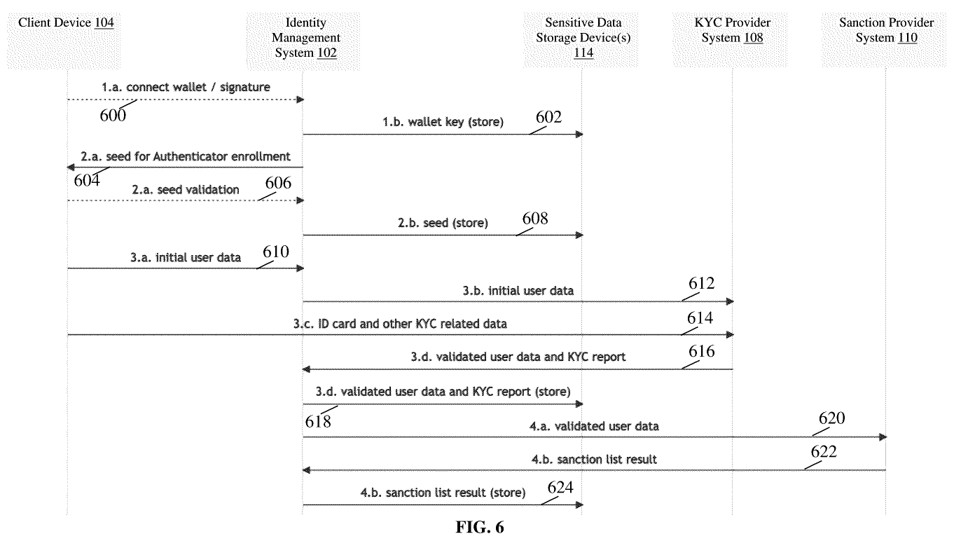

Referring back to the client device 104, in this example, the client device 104 also includes an identity management frontend 130, which is configured to manage enrollment of the user of the client device 104 and otherwise interface with the identity management system 102 (e.g., to authenticate a user). User enrollment will be described and illustrated in detail below with reference to FIG. 6, for example.

The KYC provider system 108 and the sanction provider system 110 also facilitate enrollment of a user of the client device 104. Each of these devices includes a processor coupled to a memory and configured to execute instructions stored in the memory to carry out various tasks as described and illustrated by way of the examples herein. The KYC provider system 108 ingests user-related data, including PII and other sensitive data, and provides a verification via a regulated procedure. In one example, the KYC provider system 108 can be hosted by Persona Identities, Inc. of San Francisco, California, for example.

The sanction provider system 110 also ingests sensitive data and is configured to provide a sanction report in response indicative of whether the sensitive data is associated with a sanctioned user. The sanction provider system 110 can be configured to analyze a sanctions list based on the sensitive data, for example. In one example, the sanction provider system 110 can be hosted by IVXS UK Limited, trading as ComplyAdvantage, of London, United Kingdom.

Each of the sensitive data storage device(s) 114 and access token storage device(s) 112 can be database server(s) or any other types of data storage devices. The identity management system 102 in some examples uses the sensitive data storage device(s) 114 to store encrypted sensitive data obtained during a user enrollment process. Optionally, the identity management system 102 can use the access token storage device(s) 112 to store a reference returned by the sensitive data storage device(s) 114 to the identity management system 102, which is also referred to herein as a pseudonymized access token. The access token storage device(s) 112 can be a MongoDB™ database provided by MongoDB Inc. of New York, New York.

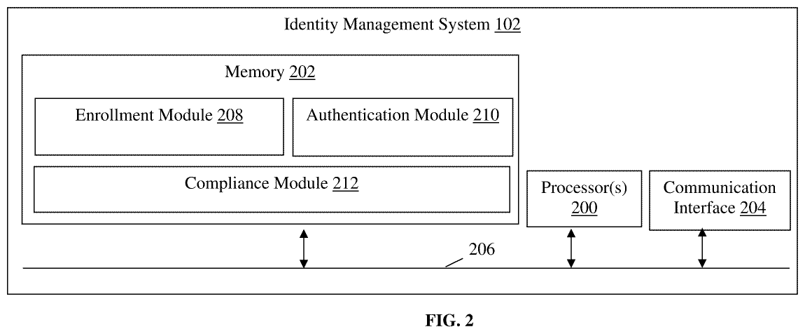

FIG. 2 is a component diagram of the identity management system 102, in accordance with one or more examples of the disclosed technology. The identity management system 102 can include processor(s) 200, memory 202, and a communication interface 204 coupled together by a system bus 206. The processor(s) 200 can include one or more microprocessors, microcontrollers, digital signal processors, co-processors or the like or combinations thereof capable of executing instructions stored in the memory 202 and operating upon stored data.

The memory 202 of the identity management system 102 can include, in some implementations, one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, flash memory, solid state drives (SSDs), non-transitory computer-readable medium, and the like), for storing files, applications, executable instructions, and/or data.

The memory 202 of the identity management system 102 can contain an operating system (“OS”) that can run program(s), which are also referred to herein as modules. The program(s) can perform one or more functions of the disclosed examples. The programs can include, for example, an enrollment module 208, an authentication module 210, and a compliance module 212, although other programs can be included in other examples. The enrollment module 208 is configured to ingest user-related sensitive data and communicate with the KYC provider system 108 to verify user identities and issue access tokens, as described in more detail below with reference to FIG. 6.

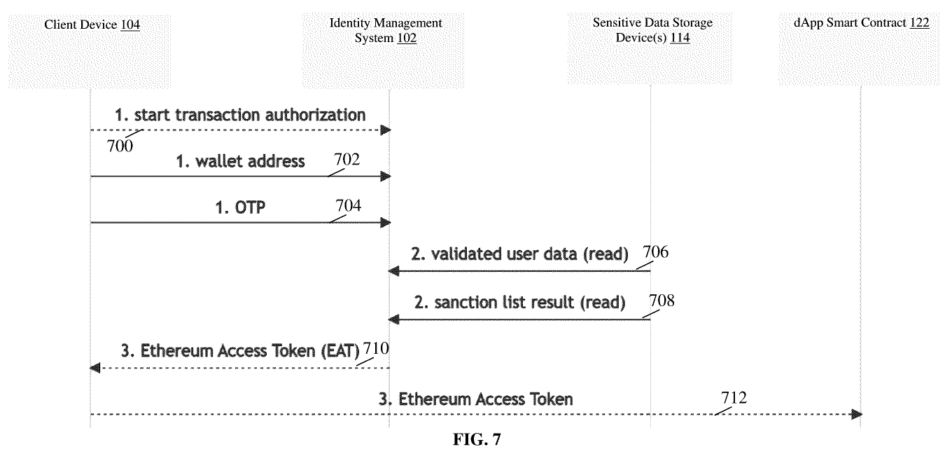

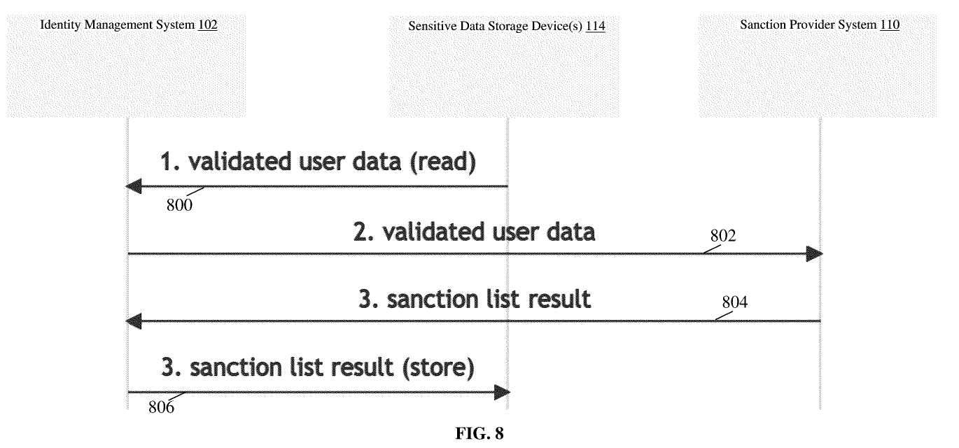

The authentication module 210 is configured to utilize stored access tokens and a compliance check to authorize transactions in response to requests from the dApp frontend 120. The operation of the authentication module 210 is described in more detail below with reference to FIG. 7. The compliance module 212 is configured to ingest user-related sensitive data and communicate with the sanction provider system 110 to implement a periodic user sanction list verification in accordance with a screening process, as described in more detail below with reference to FIG. 8. The memory 218 can also include any combination of one or more databases (e.g., relational databases) controlled by memory controller devices (e.g., server(s)) or software, such as document management systems.

The communication interface 204 of the identity management system 102 is configured to facilitate communication with external or internal systems. The communication interface 204 can include a serial port, a parallel port, a general-purpose input and output (GPIO) port, a game port, a universal serial bus (USB), a micro-USB port, a high-definition multimedia (HDMI) port, a video port, an audio port, a Bluetooth™ port, an NFC port, an Ethernet port, another like communication interface, or any combination thereof. The communication interface 204 can include a transceiver to communicate with compatible devices, for example via short range, long range (e.g., cellular, local area networks (LAN), wide area networks (WAN), etc.), or similar technologies that enables the identity management system 102 to communicate via the communication network(s) 116 as described herein.

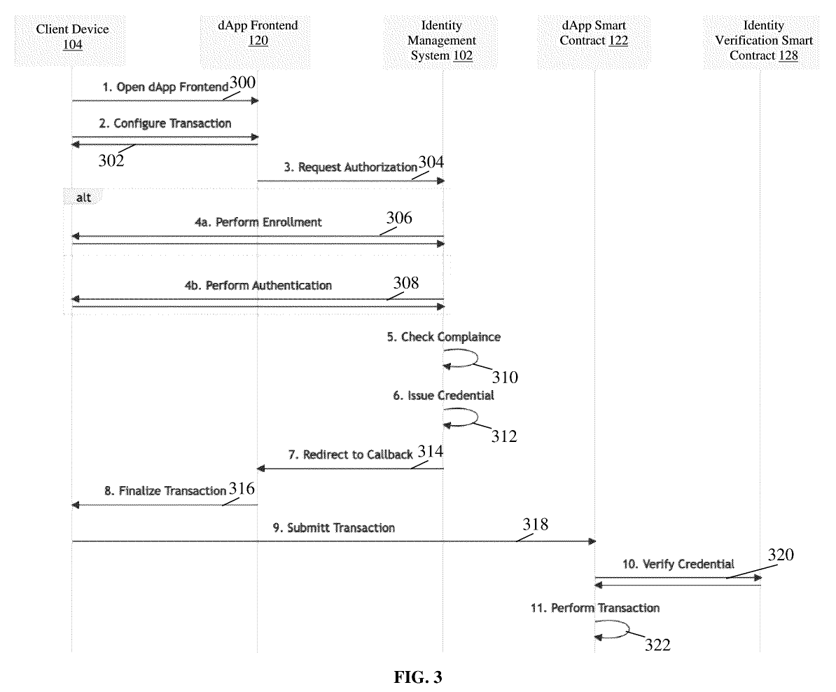

Referring now to FIGS. 3-9, flow and timing diagrams are disclosed that illustrate various exemplary methods in accordance with one or more examples of the disclosed technology. Various steps of the exemplary methods illustrated in FIGS. 3-9 may be performed by the respective systems illustrated in FIG. 1, each of which includes a processor and a memory in communication with the processor and storing instructions. When executed by the processor, the stored instructions cause the respective systems to perform certain functions, such as the step(s) attributed to those systems, as described and illustrated herein with reference to the method of FIGS. 3-9.

Referring more specifically to FIG. 3, a timing diagram of an example method for identity verification to authorize transactions in decentralized networks is illustrated, in accordance with one or more examples of the disclosed technology. In step 300, a user interfaces with the client device 104 to execute the dApp frontend 120 with the intention to perform an action (e.g., transfer of cryptocurrency) requiring compliance. The dApp frontend 120 is preconfigured to integrate with the identity management system 102 to facilitate authorization of transactions carried out in a decentralized network (e.g., the blockchain network 106) in a manner that complies with regulations and provides increased security.

In step 302, the client device 104 (e.g., the dApp frontend 120 executing on the client device 104) configures the transaction requiring authorization by generating transaction data (e.g., input parameters to a function call submitted as values to the dAppfrontend 120 by a user of the client device 104). In one example the transaction corresponds to execution of a function within the dApp smart contract 122, although other types of transactions can also be facilitated via the dApp frontend 120.

In step 304, the dApp frontend 120 sends a request for authorization to the identity management system 102, such as to the transaction authorization endpoint 126 for example. The dApp frontend 120 can be configured to generate a prompt on a display of the client device 104 to facilitate initiation of the authorization request (e.g., an XMLHttpRequest (XHR)) when submitted or selected by a user.

In some examples, the following parameters are included in the request for authorization: the wallet address that wants to perform the transaction, chain ID in which the transaction will be performed (e.g., “1” for Ethereum mainnet), smart contract address that the transaction will use (e.g., the address on the blockchain network 106 of the dApp smart contract 122), function signature of a function associated with the transaction, transaction data generated in step 302, redirect uniform resource locator (URL) that the identity management system 102 should use for a callback after authorizing the user to perform the transaction, and/or dApp state that the identity management system 102 will return so that the dApp frontend 120 can rebuild the state of the user performing the transaction. Other parameters and values can also be included in the authorization request in other examples.

In step 306, the identity management system 102 performs an initial enrollment in the case of the transaction originating from a new user of the client device 104. The enrollment can be performed using the identity management frontend 130 and the KYC provider system 108 and a multi-factor authentication process. In step 308, the identity management system 102 performs authentication for existing users, which can include authenticating via an SMS on-time passcode (OTP) or time-based OTP (TOPT) process, for example. Thus, steps 306 and 308, each of which will be described in more detail below, are alternatives depending on whether the identity management system 102 determines based on stored data that the authorization request originated with a new or existing user, respectively.

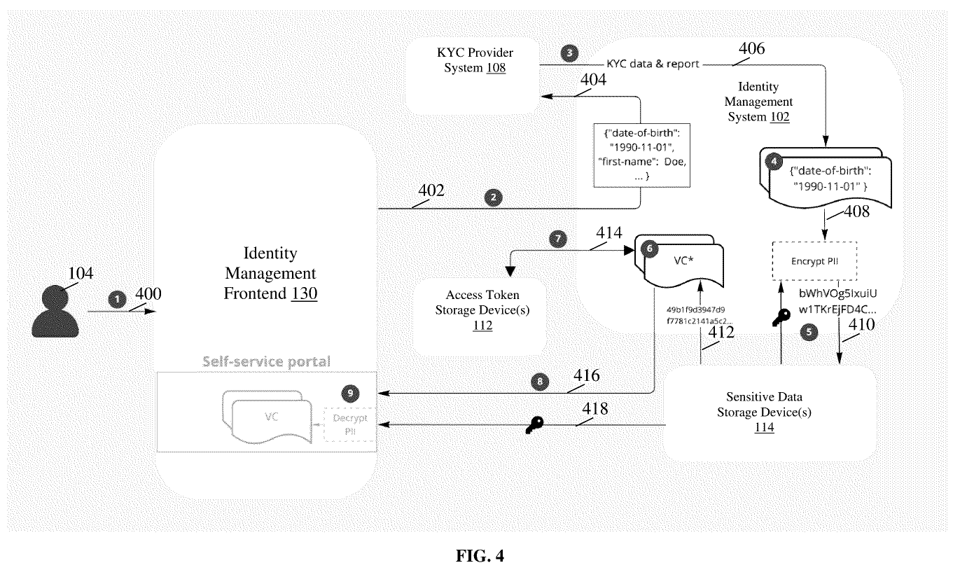

FIG. 4 is a flow diagram of an example method for communicating and storing sensitive data to facilitate improved identity management and verification, in accordance with one or more examples of the disclosed technology. The method illustrated in FIG. 4 is a higher-level process illustrating exemplar data flow within the network environment 100 while FIG. 6 illustrates a lower level or more granular data flow process as compared to FIG. 4, which specifically implements a user enrollment, as explained in more detail below. In step 400, a user of the client device 104 submits their date of birth (DOB) via interfacing with the identity management frontend 130 executing on the client device 104. While DOB is used as the particular data in this example, other types of data can be submitted to the identity management frontend 130, such as to facilitate authentication and enrollment of the user as explained in more detail below with reference to FIG. 6.

In step 402, the identity management frontend 130 sends the DOB, and optionally other information such as the user's first name, last name, and nationality, to the identity management system 102. In step 404, the identity management system 102 sends an inquiry to the KYC provider system 108 that includes the information received in step 402 to initiate an identity verification.

In step 406, the KYC provider system 108 sends an inquiry result of the identity verification to the identity management system 102 in response to the inquiry request. The inquiry result includes a report and can be in a JavaScript Object Notation (JSON) format, although other formats can also be used.

In step 408, the identity management system 102 encrypts the DOB, and optionally other information received with the inquiry result, using a symmetric key, which can be generated with a library associated with a host of the sensitive data storage device(s) 114, for example. In some examples, a different key is used every time a value is encrypted, and the key is encrypted using public keys generated by remote Hardware Security Modules (HSMs) managed by a Key Management System (KMS) of the host of the sensitive data storage device(s) 114.

In step 410, the identity management system 102 receives the encrypted data from the identity management system 102. The sensitive data storage device(s) 114 then generate and return to the identity management system 102 a unique reference value for the stored encrypted data. Thus, the sensitive data storage device(s) 114 advantageously never have access to a plaintext version of the user's sensitive data (i.e., the DOB in this example). Other data storage methods and types of encryption can also be used in other examples. For example, client-side encryption, optionally within the initial verification process, using user private keys can also be used. In other examples, decentralized storage services (e.g., InterPlanetary File System (IPFS)) can be used to enable fully self-sovereign and user-owned data vaults.

Optionally, the identity management system 102 can also redact sensitive data from the report received from the KYC provider system 108 in step 406 and replace the redacted data with references to IDs for the access tokens containing the original sensitive data. This modified report can also be provided by the identity management system 102 to the sensitive data storage device(s) 114 for storage in step 410.

In step 412, the sensitive data storage device(s) 114 returns the unique reference value for the stored encrypted data to the identity management system 102. The identity management system 102 then generates an access token (referred to herein as a pseudonymized access token) that includes the reference value and a generated Universally Unique Identifier (UUID) for the user.

In step 414, the identity management system 102 stores the pseudonymized access token, such as in the access token storage device(s) 112, for example, although the pseudonymized access token can be stored locally and/or in another location in the network environment 100 in other examples.

In step 416, the identity management system 102 can subsequently return the pseudonymized access token in response to a request from a self-service portal of the identity management frontend 130. The self-service portal is a facility that allows enrolled users to log in and view their data stored at the sensitive data storage device(s) 114. Thus, the user is authenticated prior to the identity management frontend 130 fetching the pseudonymized access token.

In step 418, the sensitive data storage device(s) 114 returns encrypted data in response to a request from the self-service portal of the identity management frontend 130. The pseudonymized access token contains the unique reference to stored encrypted data. Thus, the identity management frontend 130 is configured to extract the unique reference from the pseudonymized access token, which is provided to the sensitive data storage device(s) 114. In response, the sensitive data storage device(s) 114 provide the encrypted stored data based on the unique reference and the identity management frontend 130 is configured to decrypt the data and reconstruct the sensitive data to be displayed on the client device 104.

In some examples, requests from the identity management system 102 to the sensitive data storage device(s) 114 can be authenticated using a JSON Web Token (JWT) signed by a KMS, for example. Additionally, after user authentication, the identity management frontend 130 can make authenticated requests to the identity management system 102 to get a JWT for the sensitive data storage device(s) 114 for the user. This JWT also is signed by the KMS and return to the identity management frontend 130 to facilitate calls to the sensitive data storage device(s) 114 (e.g., in step 418). Advantageously, the sensitive data is only accessible in plaintext format at the client device 104.

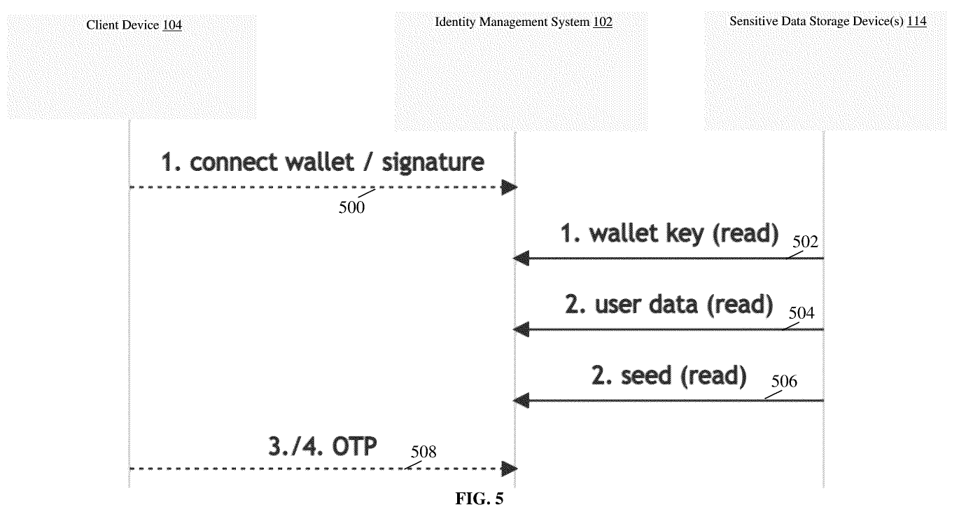

FIG. 5 is a timing diagram of an example method for facilitating a self-service portal for identity management, in accordance with one or more examples of the disclosed technology. To facilitate a login to the self-service portal of the identity management frontend 130, in step 500, a user of the client device 104 initiates a multi-factor login process, with the first factor in this example being a wallet signature that is provided to the identity management system 102.

In steps 502-506, the sensitive data storage device(s) 114 return user data from the sensitive data storage device(s) in response to request(s) from the identity management system 102. The identity management system 102 can obtain the user data as explained in more detail above with reference to FIG. 4.

In step 508, the user of the client device 104 provides a second factor to the identity management system 102, which can be in the form of an OTP. If the OTP is validated, then the user is provided access to the self-service portal of the identity management frontend 130, at which time the user can retrieve its sensitive data as also explained in more detail above with reference to FIG. 4.

FIG. 6 is a timing diagram of an example method for enrolling users in an identity management system, in accordance with one or more examples of the disclosed technology. Thus, FIG. 6 provides a more granular example of the data flow illustrated of FIG. 4, specifically applied to user enrollment performed in step 306 of FIG. 3. In step 600, the user of the client device 104 initiates a multi-factor authentication process with the identity management system 102. Initially, the user validates the ownership of the wallet associated with the wallet application 118 by providing wallet signature to the identity management system 102. In step 602, the identity management system 102 verifies the wallet signature or key in the sensitive data storage device(s) 114.

In step 604, the identity management system 102 provides a seed or secret to the client device 104 to enroll an authenticator application. In step 606, the client device 104 validates the seed with the identity management system 102 and, in step 608, the identity management system 102 stores the seed in the sensitive data storage device(s) 114.

In step 610, the user of the client device 104 provides initial user identity data via the identity management frontend 130 to the identity management system 102 that, in step 612, provides to the KYC provider system 108 to initiate a KYC process between the KYC provider system 108 and the client device. Specifically, in step 614, the client device 104 can provide an ID card and/or other KYC-related identity data to the KYC provider system 108 at the request of the KYC provider system.

In some examples, the identity management system 102 uses a regulated third-party KYC provider system 108 to verify the user behind a wallet (e.g., an Ethereum wallet). The KYC provider system 108 can support any number of verification steps including biometric verification, document verification, ID document face-match, and/or liveness detection, for example. In some examples, the initial user data provided in steps 610-612 and/or the additional user data provided in step 614 can include a full name, date of birth, location of birth, nationality ID card, expiration, ID card issuer, ID card number, and/or a face image.

In step 616, the KYC provider system 108 returns validated user data and a KYC report to the identity management system 102 in examples in which the user is validated. In step 618, the identity management system 102 stores the validated user data and the KYC report in the sensitive data storage device(s) 114 in the manner explained in more detail above with reference to FIG. 4.

In step 620, the identity management system 102 sends the validated user data or a portion thereof to the sanction provider system 110. For example, the identity management system 102 can send the user's full name, DOB, and/or nationality. The sanction provider system 110 is configured to compare the user data against a sanction list to confirm sanction compliance. The sanction analysis can be performed periodically as will be described and illustrated in more detail below with reference to FIG. 8. In step 622, the sanction provider system 110 returns a sanction list result to the identity management system 102 that, in step 624, stores the sanction list result in the sensitive data storage device(s) 114, also in the manner explained in more detail above with reference to FIG. 4. Once the user is enrolled, the identity management system 102 optionally stores an address of the user's wallet in a local or external registry.

Referring back to FIG. 3, in examples in which the user that requested authorization in step 304 is not determined to be enrolled at the identity management system, then an authentication process is initiated in step 308. FIG. 7 is a timing diagram of an example method for authorizing a user to perform a compliant transaction on a blockchain network via identity verification, in accordance with one or more examples of the disclosed technology. In step 700, the client device 104 initiates a transaction authorization via the identity management frontend 130 as prompted via the dApp frontend 120, for example, as explained above with reference to steps 300-304.

In step 702, the client device 104 sends the address of the wallet associated with the wallet application 118 and, in step 704, an OTP via an authenticator application enrolled as explained above in step 604 of FIG. 6, for example. In step 706, the sensitive data storage device(s) 114 retrieve validated user data and, in step 708, sanction list result from the sensitive data storage device(s) 114 in the manner explained above with reference to FIG. 4. Thus, verified user data and sanction list result are used by the identity management system 102 to confirm compliance.

In step 710, the identity management system 102 generates an EAT, as will be explained in more detail below with reference to step 312 of FIG. 3. In step 712, the client device 104 executing the dApp frontend 120 sends the EAT to the dApp smart contract 122 with a transaction to facilitate verification of that EAT credential via the identity verification smart contract 128, also as explained in more detail below with reference to steps 318-320 of FIG. 3.

Referring again to FIG. 3, in step 310, the identity management system 102 performs a compliance check based on interaction with the sanction provider system 110. In some examples, the identity management system 102 performs continuous or periodic sanction list monitoring and stores sanction list result as explained with reference to step 624 of FIG. 6, for example. In these examples, the identity management system 102 can perform a comparison of validated user identity data against a stored sanction list result to check compliance in step 310 of FIG. 3. Other methods for confirming sanction compliance can also be used in other examples.

FIG. 8 is a timing diagram of an example method for periodic user sanction list verification, in accordance with one or more examples of the disclosed technology. In step 800, the sensitive data storage device(s) 114 provider validated user data to the identity management system 102 in response to a request from the identity management system. The validated user data could have been obtained as described above with reference to step 616 of FIG. 6 and stored as described above with reference to step 618 of FIG. 6, for example.

In step 802, the identity management system 102 sends the obtained validated user data to the sanction provider system 110 to initiate a sanction list check in compliance with sanction screening requirements, as described above with reference to step 620 of FIG. 6. In step 804, the sanction provider system 110 returns the sanction list result indicating whether the validated user data matches a stored sanction list record, also as described above with reference to step 622 of FIG. 6. In step 806, the identity management system 102 updates the sanction list result in the sensitive data storage device(s) 114.

With the periodic sanction screening and updating of the sanction list result in the sensitive data storage device(s) 114, the identity management system 102 can check sanction compliance in step 310 of FIG. 3 without performing the steps described and illustrated with reference to FIG. 8 synchronously with processing transaction authorization. Instead, the identity management system 102 can query the sensitive data storage device(s) 114 using validated user data to check sanction compliance without communicating with the sanctions provider system 110.

Referring back to FIG. 3, in step 312, the identity management system 102 issues the access token in iterations in which the compliance check was determined by the identity management system 102 to be successful based on the sanction list result correlated to the validated user data for the user of the client device 104. The access token facilitates satisfaction of critical regulatory requirements, and cannot be traded out of a verified wallet. In some examples, the access token contains claims made by an issuer about a subject, with one or more of those entities optionally identified by a decentralized identifier (DID), metadata (e.g., access token type, issuance date, or issuer ID), and a proof object allowing anyone to verify the authenticity, provenance, and integrity of the access token using cryptography. Thus, the access tokens enable a flow of issuance, presentation, and verification of credentials in a way that is privacy-preserving, machine-verifiable, and cryptographically secure.

The access token can be exposed as an Ethereum access token (EAT) in examples within the Ethereum blockchain network 106. Implementing the access token as an EAT requires the user to perform an additional authentication at the time of a transaction (e.g., SMS OTP), resulting in a signature from the identity management system to be directly verified by the integrating dApp frontend 120 on-chain, which results in more robust security through connecting a verified identity to a wallet at the time of transaction. The EAT is a time-sensitive token that allows access to certain smart contracts, and is passed in a blockchain transaction, which is then verified by a smart contract that checks that the function being called satisfies the verified parameters and that the EAT was issued by the correct entity, as explained in more detail below with reference to step 320 of FIG. 3.

In some examples, the EAT can be implemented in accordance with Ethereum Improvement Proposal (EIP) 712, which is incorporated by reference herein in its entirety. Thus, the EAT is in the form of a signed message that complies with the Ethereum standard for hashing and signing message and is used to pass trusted compliance information from the off-chain identity management system 102 to the on-chain identity verification smart contract 128. The EAT contains no direct PII of the user and only reveals that the wallet address associated with the wallet application 118 has successfully enrolled and authenticated via the compliance required by the integrating dApp frontend 120 and/or dApp smart contract 122.

Each EAT that is signed and issued by the identity management system 102 specifies what on-chain action a user requested access to (e.g., the transaction configured in step 302), and what they are authenticating themselves against. If a transaction is attempted with an EAT that does not allow such a transaction, then the transaction fails, as also explained in more detail below with reference to step 320 of FIG. 3.

While the examples described and illustrated herein with reference to FIG. 3 implement the access token as an EAT, in other examples, the access token can be implemented as a non-transferable token (e.g., an NFT badge according to Ethereum Request for Comments (ERC) 1238, which is incorporated by reference herein in its entirety). The NFT badge represents compliance information about a wallet address on-chain, which allows the integrating dApp frontend 120 to verify status on-chain without additional interaction with the identity management system 102. In other words, the dAPP frontend 120 verifies a user's wallet balance to hold the correctly issued NFT.

Other types of access tokens can also be used in other examples. Specifically, the identity management system 102 can issue custom access tokens (e.g., accredited investor status or credit scores), such as within market that desire to restrict high-risk wallets from access, which implement custom protocol rules, such as excluding wallets implicated in hacks or tumblers, for example.

Optionally the registry maintained as described above with reference to FIG. 6, which is used to store wallet addresses of enrolled users, can be consulted based on the wallet address received with the authorization request in step 304 to facilitate authentication in some examples. If the wallet address matches a wallet address in the registry, then the identity management system 102 can issue the access token without requiring additional steps (e.g., step 310) of the authentication flow described and illustrated herein with reference to step 308.

In step 314, the identity management system 102 redirects the user of the client device 104 via a callback URL of the integrating dApp frontend 120. The redirect message includes the access token issued in step 312. The callback URL was received by the identity management system 102 from the dApp frontend 120 with the authorization request in step 304 in this example. Optionally, the redirect message can further include the state of the dApp frontend 120 that was also provided to the identity management system 102 from the dApp frontend 120 with the authorization request in step 304.

In step 316, the dApp frontend 120 finalizes the transaction initially configured in step 302. The finalized transaction includes the valid access token received by the dApp frontend 120 with the redirect message. In the finalized transaction, the EAT contains two fields in some examples in which the access token is an EAT: (1) ethereumAccessToken.signature and (2) ethereumAccessToken.expiry. The finalized transaction is then presented to the user of the client device 104 for signing via a user interface of the dApp frontend 120 and the user's wallet application 118. In some examples, the access token and/or the dApp state in the redirect message are encoded (e.g., base64 encoded) and are therefore decoded by the dApp frontend 120 in step 316. To facilitate transaction finalization, the dApp frontend 120 can be configured to repopulate the user session using the dApp state included in the redirect message. Additionally, the finalized transaction includes the parameters included in the configured transaction in step 302 and provided to the identity management system 102 via the authorization request in step 304.

In step 318, the client device 104 submits the signed finalized transaction to the dApp smart contract 122. The dApp frontend 120 can be configured with the address of the dApp smart contract 122 in some examples, although the dApp smart contract 122 address can be provided and/or identified in other ways in other examples.

In step 320, the dApp smart contract 122 communicates with the identity verification smart contract 128 to call functions enforcing compliance with a verified access token. In this example, the functions executed by the dApp smart contract 122 (e.g., as identified in the configured transaction, authorization request, and finalized transaction) that require compliance can be modified to initiate the access token verification process with the identity verification smart contract 128.

In response to the verification request from the dApp smart contract 122, the identity verification smart contract 128 is configured to check that the transaction and/or function being called satisfies the verified parameters and that the access token was issued by the correct entity (i.e., the identity management system 102). Thus, the identity verification smart contract 128 in this example is a dedicated smart contract that consumes and verifies access tokens and outputs true for successful verifications and false for failed verifications.

The identity verification smart contract 128 also dictates the signers that are allowed to issue access tokens. While the identity management system 102 is an authorized signer and issuer of access tokens in this example, in other examples, multiple identity verification smart contracts can be deployed on the blockchain network 106, which are managed by any number of different access token issuers such that the relevant verifier or identity verification smart contract can be specified depending on the trust level required.

In step 322, the dApp smart contract 122, in iterations in which the identity verification smart contract 128 returned an indication that the verification was successful, performs the transaction by executing the function identified in the finalized transaction using the parameters also included in the finalized transaction. Accordingly, in the example illustrated in FIG. 3, the identity management system 102 is an off-chain issuer of access tokens that are provided to client devices of authenticated users. The client devices then access on-chain applications or smart contracts (e.g., dApp smart contract 122) with the access tokens. The smart contracts are configured to verify the access tokens via interaction with other on-chain smart contracts. Thus, this technology advantageously provides a system able to make on-chain guarantees of off-chain verifications, maintains user pseudonymity without storing any on-chain sensitive data, and provides granular access control of applications.

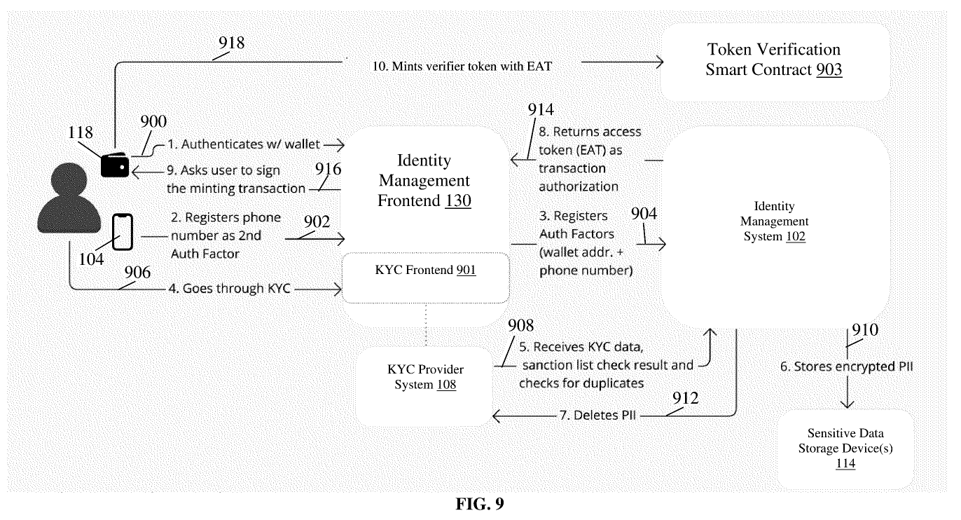

FIG. 9 is a flow diagram of an example method for providing an on-chain representation of an off-chain verified identity, in accordance with one or more examples of the disclosed technology. In the examples described above, the access token (e.g., EAT) is generated or issued (e.g., in step 312 of FIG. 3) synchronously with a request to authorize a transaction from the dApp frontend 120. However, in other examples, an on-chain representation of an off-chain verified identity can be facilitated asynchronously via a verifier token minted with an access token to provide proof (e.g., for future transactions) that a user has completed the identity verification described and illustrated above irrespective of any initiated transaction. In these examples, the verifier token is associated with a particular wallet that allows other entities (e.g., smart contracts) to verify that the wallet is linked to a verified identity. Advantageously, the minted verifier token does not hold or reveal any personal data.

Referring to FIG. 9, in step 900, the user of the client device 104 authenticates with the identity management frontend 130 via the wallet associated with the wallet application 118. In one example, users can authenticate using Sign-In with Ethereum described in ERC-4361, which is incorporated by reference herein in its entirety, although other authentication methods can also be used in other examples.

In step 902, the user of the client device 104 registers their phone number with the identity management frontend 130 as a second authentication factor to facilitate SMS OTP. In step 904, the identity management system 102 receives the wallet address and phone number as authentication factors from the identity management frontend 130.

In step 906, the user goes through a KYC process, which in this example utilizes a KYC frontend 901 executing on the client device 104 and communicably coupled to the KYC provider system 108, although other methods of facilitating the KYC process can also be used in other examples. Thus, the user can submit personal information (e.g., first and last name, nationality, and/or DOB) and/or upload a copy of an ID document, for example.

In step 908, the KYC frontend 901 provides the user data obtained from the user to initiate the KYC process to the KYC provider system 108, and the KYC provider system 108 provides an indication of successful completion of the KYC process to the identity management system 102, as described above. In this example, the KYC provider system 108 is also configured to perform the sanction list check and provider a result of the same to the identity management system 102. Thus, a separate sanction provider system is not utilized in this example.

In step 910, the identity management system 102 stores the user data and KYC and sanction list result in the sensitive data storage device(s) 114 in an encrypted format as described above with reference to step 410 of FIG. 4, for example. In step 912, the identity management system 102 deletes the user data via communication with the KYC provider system 108.

In step 914, the identity management system 102 verifies that the user is correctly enrolled and meets any stored required criteria and then returns a access token, which in this example is an EAT, as transaction authorization. The access token in this example grants the user the right to mint a specific token ID for their wallet address. In other words, the access token authorizes the minting transaction instead of a transaction configured and finalized by a dApp frontend 120 as described and illustrated above with reference to FIG. 3.

In step 916, the wallet application 118 prompts the user of the client device 104 to sign (e.g., with the user's private key) the minting transaction. In step 918, the wallet application 118 mints the verifier token with the access token on the blockchain network 106. Accordingly, when a future transaction is initiated (e.g., with dApp frontend 120), the identity verification smart contract 128 can be used to provide the credential verification described and illustrated above with reference to step 320.

While the examples of this technology have generally been described and illustrated herein with reference to an Ethereum Virtual Machine (EVM) compatible blockchain network (e.g., Ethereum mainnet), the blockchain network 106 can be any other type of decentralized network (e.g., Polygon mainnet, Optimism mainnet, Arbitrum One) in other examples. Additionally, one or more steps of any of the methods described and illustrated herein can be performed in parallel with one or more other steps and/or in a different order than described by way of the examples herein.

Certain embodiments of the disclosed technology are described above with reference to block and flow diagrams of systems and methods and/or computer program products according to exemplary embodiments of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a non-transitory computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the disclosed technology have been described in connection with what is presently considered to be the most practical and various embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An identity management system, comprising a processor and memory in communication with the processor and storing instructions that, when executed by the processor, are configured to cause the identity management system to:
receive a first request to authorize a first transaction from a decentralized application (dApp) frontend executing on a client device, wherein the first request comprises a wallet address, an identifier of a blockchain network, a smart contract address of a dApp smart contract, a function signature of a function associated with the first transaction and executable via the dApp smart contract, first transaction data, and a redirect address;
enroll the wallet address comprising providing user data obtained from the client device to a know your customer (KYC) provider system, receiving validated user data from the KYC provider system, providing the validated user data to a sanction provider system, and receiving a sanction list result from the sanction provider system;
issue a first access token comprising an expiration, an issuer identifier associated with the identity management system, the function signature, the smart contract address, and an indication that the wallet address has successfully enrolled; and
return a first redirect message to the client device based on the redirect address to facilitate submission of the first transaction to the dApp smart contract, wherein the first redirect message comprises the first access token and the first transaction data and the dApp smart contract is configured to execute the function after verifying the first access token via an identity verification smart contract that is on the blockchain network, inherited by the dApp smart contract, and associated with the identity management system.

2. The identity management system of claim 1, wherein the wallet address corresponds to an address on the blockchain network of a wallet associated with a user of the client device, the first transaction corresponds with execution of the function via the dApp smart contract, the first transaction data comprises one or more input parameters for the function, and the redirect address corresponds to a callback function of the dApp frontend.

3. The identity management system of claim 1, wherein the first request comprises a state of the dApp frontend following configuration of the first transaction and the first redirect message comprises the state to facilitate reconstruction of the state and finalization of the first transaction prior to submission of the first transaction by the client device.

4. The identity management system of claim 1, wherein the first access token further comprises a proof object that facilitates verification of one or more of an authenticity, a provenance, or an integrity of the first access token using cryptography.

5. The identity management system of claim 1, wherein the instructions, when executed by the processor, are further configured to cause the identity management system to:
encrypt data comprising the sanction list result and the validated user data; and
send the encrypted data to one or more sensitive data storage devices for storage.

6. The identity management system of claim 5, wherein the instructions, when executed by the processor, are further configured to cause the identity management system to:
receive a unique reference value for the encrypted data from the sensitive data storage devices after sending the encrypted data to the sensitive data storage devices;
generate and store a pseudonymized access token comprising the unique reference value;
return the pseudonymized access token in response to a second request from a self-service portal executed by the client device after user authentication, wherein the self-service portal is configured to request the encrypted data from the sensitive data storage devices using the pseudonymized access token and decrypt the encrypted data for display on a display device of the client device.

7. The identity management system of claim 5, wherein the instructions, when executed by the processor, are further configured to cause the identity management system to:
receive a second request to authorize a second transaction from the dApp frontend, wherein the second request comprises the wallet address, the identifier, the smart contract address, the function signature, second transaction data, and the redirect address;
authenticate the wallet address via a first factor via an authenticator application and a one-time passcode (OTP) received from the client device and a second factor via the validated user data and the sanction list result retrieved from the sensitive data storage devices;
issue a second access token comprising the expiration, issuer identifier, function signature, dApp smart contract address, and indication that the wallet address has successfully enrolled; and
return a second redirect message to the client device based on the redirect address to facilitate submission of the second transaction to the dApp smart contract, wherein the second redirect message comprises the second access token and the second transaction data and the dApp smart contract is configured to execute the function after verifying the second access token via the identity verification smart contract.

8. The identity management system of claim 1, wherein the blockchain network comprises an Ethereum Virtual Machine (EVM) compatible blockchain, the first access token comprises an Ethereum access token (EAT), and transfer of the EAT out of a wallet corresponding to the wallet address is restricted.

9. The identity management system of claim 1, wherein the identity verification smart contract is configured to determine that the first transaction or function satisfies one or more verified parameters and that the first access token was issued by a correct entity.

10. A method for identity verification to authorize transactions in decentralized networks, the method implemented by one or more identity management systems and comprising:
receiving a request to authorize a transaction from a decentralized application (dApp) frontend executing on a client device, wherein the request comprises a wallet address, an identifier of a blockchain network, a smart contract address of a dApp smart contract, a function signature of a function associated with the transaction and executable via the dApp smart contract, transaction data, and a redirect address;
authenticating the wallet address via a multi-factor authentication process and validated user data and a first sanction list result retrieved from one or more sensitive data storage devices;
issuing a access token comprising an expiration, an issuer identifier, the function signature, the smart contract address; and
returning a redirect message to the client device based on the redirect address to facilitate submission of the transaction to the dApp smart contract, wherein the redirect message comprises the access token and the transaction data and the dApp smart contract is configured to execute the function after verifying the access token via an identity verification smart contract that is on the blockchain network and inherited by the dApp smart contract.

11. The method of claim 10, wherein the wallet address corresponds to an address on the blockchain network of a wallet associated with a user of the client device, the transaction corresponds with execution of the function via the dApp smart contract, the transaction data comprises one or more input parameters for the function, and the redirect address corresponds to a callback function of the dApp frontend.

12. The method of claim 10, wherein the request comprises a state of the dApp frontend following configuration of the transaction and the redirect message comprises the state to facilitate reconstruction of the state and finalization of the transaction prior to submission of the transaction by the client device.

13. The method of claim 10, wherein the blockchain network comprises an Ethereum Virtual Machine (EVM) compatible blockchain, the access token comprises an Ethereum access token (EAT), and transfer of the EAT out of a wallet corresponding to the wallet address is restricted.

14. The method of claim 10, wherein the identity verification smart contract is configured to determine that the transaction or function satisfies one or more verified parameters and that the access token was issued by a correct entity.

15. The method of claim 10, further comprising authenticating the wallet address further via an authenticator application and a one-time passcode (OTP) received from the client device.

16. The method of claim 10, further comprising periodically:
obtaining the validated user data from the sensitive data storage devices and a second sanction list result from a sanction provider system using the validated user data; and
encrypting the second sanction list result; and
sending the encrypted second sanction list result to the sensitive data storage devices for storage.

17. A non-transitory computer readable medium having stored thereon instructions comprising executable code that, when executed by one or more processors, causes the processors to:
deploy on a blockchain network a token verification smart contract and an identity verification smart contract, wherein the identity verification smart contract includes an extension with a connector to the token verification smart contract and is inherited by a decentralized application (dApp) smart contract associated with a dApp;
authenticate a user of a client device based on a wallet associated with the user, wherein the wallet has a corresponding wallet address on the blockchain network;
receive from one or more external systems validated user data indicating successful completion of a know your customer (KYC) process by the user and a positive sanction list result for the user; and
issue a access token that authorizes a minting transaction to mint, for the wallet address on the blockchain network, a verifier token that comprises the access token, wherein the token verification smart contract is configured to provide credential verification via the extension for a transaction associated with the dApp based on the verifier token.

18. The non-transitory computer readable medium of claim 17, wherein the executable code, when executed by the processors, further causes the processors to obtain a phone number from the client device to facilitate one-time passcode (OTP) authentication of the user in advance of the transaction.

19. The non-transitory computer readable medium of claim 18, wherein the executable code, when executed by the processors, further causes the processors to:
encrypt data comprising the sanction list result, the validated user data, the wallet address, and the phone number; and
send the encrypted data to one or more sensitive data storage devices for storage.

20. The non-transitory computer readable medium of claim 17, wherein the blockchain network comprises an Ethereum Virtual Machine (EVM) compatible blockchain, the access token comprises an Ethereum access token (EAT), and transfer of the EAT out of the wallet is restricted.
